(19) United States
(12) Patent Application Publication
(10) Pub. No.: US 2010/0290232 A1
(43) Pub. Date: Nov. 18, 2010

(54) Non-axisymmetric Optical Device

(76) Inventors: Chih-Hung Wei, Tucheng City (TW); Ming-Chang Wu, Tucheng City (TW); Chih-Chun Wen, Tucheng City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/464,968

(22) Filed: May 13, 2009

(51) Int. Cl. F21V 7/00

(52) U.S. Cl. 362/296.01

(57) ABSTRACT

The present invention is an optical device that is not axially symmetric; comprising of a lampshade at least; wherein, an optical unit mounted to the transverse of lampshade, an illuminant mounted inside the lampshade where corresponding to the center of inner lateral to the optical unit; meanwhile, the optical unit is geometrically structured in a non-axisummetric configuration while the optical unit is fitted a reflector with plurality of cascades along the ring at the external lateral; thus, a refraction or reflection against the light emitted from the illuminant can be performed when permeating through the optical unit that beams a strip light pattern achievable.

### BACKGROUND OF THE INVENTION

1. Field of the Invention

The present invention relates generally to a non-axisymmetric optical device, and more particularly to an optical device that can take the advantage of an optical unit for its accommodation to perform a refraction or reflection of light so that an illuminant is enabled to beam a strip light pattern.

2. Description of the Prior Art

As a rule, the conventional lamp is comprised of a lampshade, an illuminant mounted in the lampshade and a transparent enclosure cover; such a lamp allows the illuminant to emit the light out from the transparent enclosure cover directly or emit the light to be reflected by the lampshade out of the enclosure cover to perform the desired illumination; meanwhile, a protection from the installation of transparent enclosure to the illuminant is achievable.

In spite of the conventional lamp abovementioned is able to perform the desired illumination; however, since the lamp is comprised of the lampshade, illuminant and transparent enclosure cover without any structural design of reflection and spotlighting of light provided for the illuminant; therefore, when taking the lamp to serve as a streetlamp is desired, the lamp fails to converge the light source effectively that leads to a weak emission light source and a scattered light pattern where a spotlighting illumination is unattainable; consequently, the conventional lamp is comparatively unable to meet the practical need where necessary.

### SUMMARY DESCRIPTION OF THE INVENTION

In view of the foregoing description of the prior art, the primary objective of the present invention is to make use of the shape from a lampshade and an optical unit to perform a refraction or reflection against the light emitted from the illuminant when permeating through the optical unit that makes the performance of beaming a strip light pattern achievable.

The foregoing objective of the present invention is attained by an optical device comprised of a lampshade at least that is not axially symmetric; wherein, an optical unit mounted to the transverse of lampshade, an illuminant mounted inside the lampshade where corresponding to the center of inner lateral to the optical unit; meanwhile, the optical unit is geometrically structured in a non-axisummetric configuration while the optical unit is fitted a reflector with plurality of cascades along the ring at the external lateral.

### BRIEF DESCRIPTION OF THE FIGURES

FIG. 1, is a schematic diagram of the cross-section view for the present invention.

FIG. 2, is a schematic diagram of the three-dimensional appearance for the optical unit of the present invention.

FIG. 3, is a schematic diagram of the top view for the present invention.

FIG. 4, is a schematic diagram of the preferred embodiment for the present invention.

FIG. 5, is a schematic diagram of the preferred embodiment under a reflective configuration for the present invention.

### DETAILED DESCRIPTION OF THE PREFERRED EMBODIMENTS

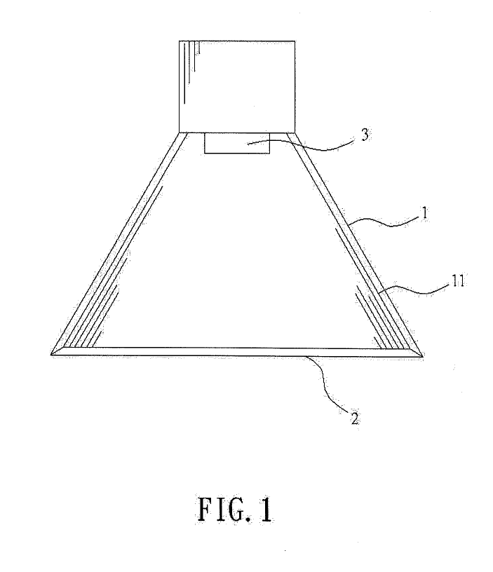

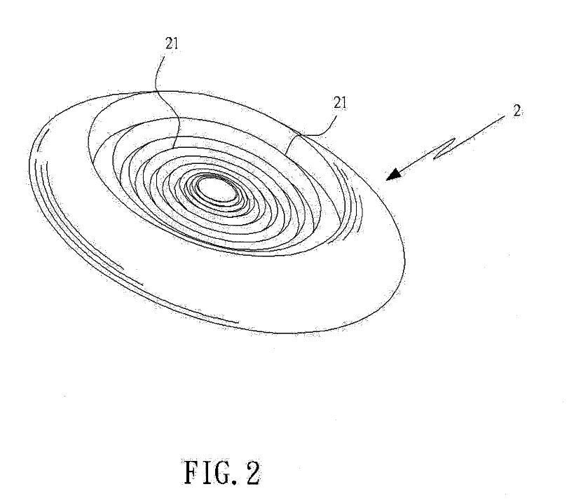

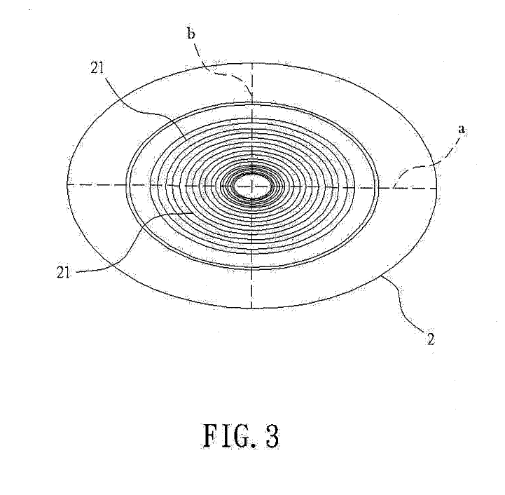

Referring to the “FIG. 1, FIG. 2 and FIG. 3” for a schematic diagram of the cross-section view for the present invention, a schematic diagram of the three-dimensional appearance for the optical unit of the present invention and a schematic diagram of the top view for the present invention; the present invention as shown in the figures is a non-axisymmetric optical device that is comprised of a lampshade 1 at least; wherein, a reflective surface 11 is fitted to the inner surface of lampshade 1, an optical unit 2 is integrated to the transverse of lampshade 1, an optical unit 2 made of reflective materials and formed in a glossy or matte surface that is pervious to light is fitted to the transverse of lampshade 1; an illuminant 3 is mounted inside the lampshade where corresponding to the center of inner lateral to the optical unit 2 while the illuminant 3 is a LED (Light Emitting Diode); meanwhile, the spacing “a” at both ends of the optical unit 2 is bigger than the spacing “b” at both sides that forms a non-axisymmetric configuration; also, a reflector 21 structured in a plurality of cascades along the ring on the inner lateral of the optical unit 2; thus, by integrating the foregoing components, a brand new optical device that is not axially symmetric is formed accordingly.

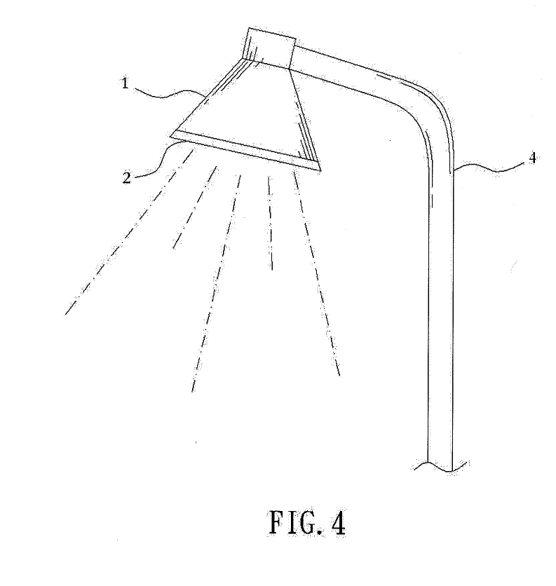

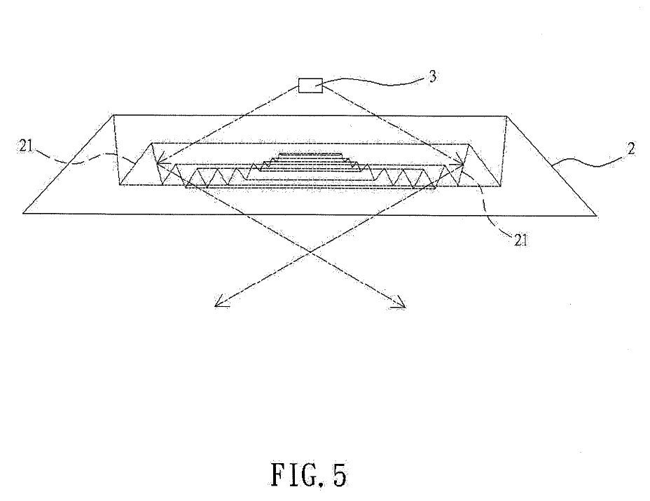

Referring to the “FIG. 4 and FIG. 5” for a schematic diagram of the preferred embodiment for the present invention and a schematic diagram of the preferred embodiment under a reflective configuration for the present invention, the present invention as shown in the figures of the preferred embodiments is accommodated to a lamppost 4 for streetlamp application; wherein, an illuminant 3 will emit and enable the light source to beam directly or refract toward the direction of optical unit 2 by permeating the reflective surface 11 (see the FIG. 1) so as to perform a full reflection for the first time; then, following the reflection from the reflector 21, the light source will be emitted out from the optical unit 2 once again to perform the reflection or refraction; and since the spacing “a” at both ends of the optical unit 2 (see the FIG. 3) is bigger than the spacing “b” at both sides (see the FIG. 3), therefore, when the light source is emitted out of the optical unit 2, by taking the advantage of the spacing “a” at both ends of optical unit (see the FIG. 3) to reflect the light source to the parallel orientation and the spacing “b” at both sides (see the FIG. 3) to spotlight the light source at the center, thus the illuminant 3 is able to beam a strip light pattern while this strip light pattern conforms to the application of streetlamp for illumination; of course, the present invention is not only suitable for the application of streetlamp, but also applicable to the place where an illumination in a strip light pattern is desired.

It is concluded from the preferred embodiments abovementioned that the present invention, a non-axisymmetric optical device, is able to take the advantage of the shape of lampshade and optical unit plus the accommodation from a reflector to deflect and divert the light emitted from the illuminant when permeating the optical unit so as to make the performance of beaming a strip light pattern achievable; moreover, the creation of the present invention in possession of the novelty and utility is more suitable to meet the need of users that is compliant with the requisites of application for an invention of patent; therefore, an application for patent is filed in accordance with the statutes of patent.

Nevertheless, the preferred embodiments aforementioned are simply some of the better preferred embodiments of the present invention; therefore, it is intended that the description of the preferred embodiments for the present invention illustrates rather than limits the present invention; that is, all the simply equivalent changes and modifications made to the contents disclosed by the present invention and the scope of patent applied for the present invention shall be resided within the scope of patent set forth below for the present invention.

What is claimed is:

1. A non-axisymmetric optical device, comprising of a lampshade at least; wherein, an optical unit mounted to the transverse of lampshade, an illuminant mounted inside the lampshade where corresponding to the center of inner lateral to the optical unit; also, a non-axisummetric configuration the geometrically structured to the optical unit and a reflector fitted to the optical unit with plurality of cascades along the ring at the external lateral; thus, a refraction or reflection of the light emitted from the illuminant can be performed when permeating through the optical unit that beams a strip light pattern.

2. A non-axisymmetric optical device as claimed in the claim 1; wherein, the inner surface of the lampshade is structured a reflective surface.

3. A non-axisymmetric optical device as claimed in the claim 1; wherein, the optical unit is made of reflective materials that are pervious to light.

4. A non-axisymmetric optical device as claimed in the claim 1; wherein, the optical unit can be glossy-surfaced or matte-surfaced.

5. A non-axisymmetric optical device as claimed in the claim 1; wherein, the illuminant is a LED (Light Emitting Diode).
